(19) United States
(12) Patent Application Publication
(10) Pub. No.: US 2011/0229698 A1
(43) Pub. Date: Sep. 22, 2011

(54) BIODEGRADABLE RESIN COMPOSITES

(75) Inventors: Robert R. Rasmussen, Lansing, NY (US); Patrick J. Govang, Ithaca, NY (US); Clayton D. Poppe, Ithaca, NY (US); Thomas P. G. Schryver, Ithaca, NY (US); Joshua Velson, Ithaca, NY (US)

(73) Assignee: E2E MATERIALS, INC., Ithaca, NY (US)

(21) Appl. No.: 13/052,058

(22) Filed: Mar. 19, 2011

Related U.S. Application Data
(60) Provisional application No. 61/315,703, filed on Mar. 19, 2010.
(60) Provisional application No. 61/315,712, filed on Mar. 19, 2010.
(60) Provisional application No. 61/424,267, filed on Dec. 17, 2010.

(51) Int. Cl. C08L 89/00; C08L 5/00; B32B 3/10; C09J 5/00; B29C 70/34; B32B 38/04

(52) U.S. Cl. 428/195.1; 106/135.1; 106/126.1; 106/156.21; 106/157.2; 156/306.3; 156/163; 156/267

(57) ABSTRACT

The present invention provides biodegradable compositions, resins comprising the same, and composites thereof.

### CROSS REFERENCE TO RELATED APPLICATIONS

The present application claims priority to U.S. provisional application Ser. Nos. 61/315,703, filed Mar. 19, 2010, 61/315,712, filed Mar. 19, 2010, and 61/424,267, filed Dec. 17, 2010, the entirety of each of which is incorporated herein by reference.

### FIELD OF THE INVENTION

The present invention relates to protein-based polymeric compositions and, more particularly, to biodegradable polymeric compositions containing protein in combination with green strengthening agents.

### BACKGROUND OF THE INVENTION

Concerns about the environment, both with respect to pollution and sustainability, are rapidly rising. Extensive research efforts are being directed to develop environment-friendly and fully sustainable “green” polymers, resins and composites that do not use petroleum and wood as the primary feed stocks but are instead based on sustainable sources such as plants. Such plant-based green materials can also be biodegradable and can thus be easily disposed of or composted at the end of their life without harming the environment. Fibers such as jute, flax, linen, hemp, bamboo, etc., which have been used for many centuries, are not only sustainable but also annually renewable. Because of their moderate mechanical properties, efforts are being directed toward their use in the reinforcement of plastics and the fabrication of composites for various applications. Such fibers may be used alone, as components of yarns, fabrics or non-woven mats, or various combinations thereof. Fully green composites fabricated using plant fibers such as jute, flax, linen, hemp, bamboo, kapok, etc., and resins such as modified starches and proteins have already been demonstrated and commercialized. High strength liquid crystalline (LC) cellulose fibers, prepared by spinning a solution of cellulose in phosphoric acid, can impart sufficiently high strength and stiffness to composites to make them useful for structural applications. However, since natural fibers are generally weak compared to high strength fibers such as graphite, aramid, etc., composites containing them typically have relatively poor mechanical properties, although they may be comparable to or better than wood. Thus, such composites are suitable for applications that do not require high mechanical performance, for example, packaging, product casings, housing and automotive panels, etc. Nonetheless these applications represent large markets, so increasing use of composites containing biodegradable natural materials should contribute substantially towards reducing petroleum-based plastic/polymer consumption.

The use of renewable materials from sustainable sources is increasing in a variety of applications. Biocomposites are materials that can be made in nature or produced synthetically, and include some type of naturally occurring material such as natural fibers in their structure. They may be formed through the combination of natural cellulose fibers with other resources such as biopolymers, resins, or binders based on renewable raw materials. Biocomposites can be used for a range of applications, for example: building materials, structural and automotive parts, absorbents, adhesives, bonding agents and degradable polymers. The increasing use of these materials serves to maintain a balance between ecology and economy. The properties of plant fibers can be modified through physical and chemical technologies to improve performance of the final biocomposite. Plant fibers with suitable properties for making biocomposites include, for example, hemp, kenaf, jute, flax, sisal, banana, pineapple, sugar cane bagasse, corn stover, straw, ramie and kapok.

Biopolymers derived from various natural botanical resources such as protein and starch have been regarded as alternative materials to petroleum plastics because they are abundant, renewable and inexpensive. The widespread domestic cultivation of soybeans has led a great deal of research into the development of biopolymers derived from their byproducts. Soy protein is an important alternative to petroleum based plastic materials because it is abundant, renewable and inexpensive. Soy proteins, which are complex macromolecular polypeptides containing 20 different amino acids, can be converted into biodegradable plastics. However, soy protein plastics suffer the disadvantages of low strength and high moisture absorption. Accordingly, there remains a need for biodegradable resins and composites thereof.

### DETAILED DESCRIPTION OF THE INVENTION

In certain embodiments, the present invention provides a biodegradable polymeric composition comprising a protein and a first strengthening agent. In some embodiments, a biodegradable polymeric composition further comprises a second strengthening agent. In some embodiments, the invention provides a resin comprising a biodegradable polymeric composition. In certain embodiments, the invention provides a composite comprising a provided resin. Such biodegradable polymeric compositions, strengthening agents, resins, and composites are described in detail herein, infra

In other aspects, the present invention provides a method for preparing a composite comprising a biodegradable polymeric composition comprising the steps of: preparing an aqueous mixture of a resin comprising a protein and first strengthening agent; coating and/or impregnating a fiber mat with the mixture; heating the impregnated mat to remove water (or otherwise drying the impregnated mat), thereby forming a substantially dry intermediate sheet (also referred to herein as a “prepreg”); and subjecting the intermediate sheet to conditions of temperature and pressure effective to form a composite comprising the biodegradable polymeric composition. Details of these, and other aspects of the invention, are provided herein, infra.

### Definitions

The term “biodegradable” is used herein to mean degradable over time by water and/or enzymes found in nature, without harming the environment.

The term “strengthening agent” is used herein to describe a material whose inclusion in the biodegradable polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

The term “curing” is used herein to describe subjecting the composition of the present invention to conditions of temperature and pressure effective to form a solid article.

The term “array” is used herein to mean a network structure.

The term “mat” is used herein to mean a collection of raw fibers joined together.

The term “prepreg” is used herein to mean a fiber structure that has been impregnated with a resin prior to curing the composition.

### Resin

In some aspects, the present invention provides a resin comprising a biodegradable polymeric composition. In some embodiments, a resin comprises a protein and a first strengthening agent. Such resin is made entirely of biodegradable materials. In some embodiments, a resin is made from a renewable source including a yearly renewable source. In some embodiments, no ingredient of the resin is toxic to the human body (i.e., general irritants, toxins or carcinogens). In certain embodiments, a provided resin does not include formaldehyde or urea derived materials.

### Protein

As generally described above, a provided biodegradable polymeric composition comprises a protein.

Suitable protein for use in a provided composition typically contains about 20 different amino acids, including those that contain reactive groups such as —COOH, —NH₂ and —OH groups. Once processed, protein itself can form crosslinks through the —SH groups present in the amino acid cysteine as well as through the dehydroalanine (DHA) residues formed from alanine by the loss of the α-hydrogen and one of the hydrogens on the methyl group side chain, forming an α,β-unsaturated amino acid. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the protein. However, the crosslinked protein is very brittle and has low strength.

Without wishing to be bound by a particular theory, it is believed that the protein concentration of a given protein source is directly proportional to the extent of crosslinking (the greater the protein concentration the greater crosslinking of the resin). Greater crosslinking in the resin produces composites with more rigidity and strength. Altering the ratio of protein to plasticizer allows those skilled in the art to select and fine tune the rigidity of the resulting composites. In some embodiments, the ratio of protein to plasticizer is about 4:1. In some embodiments, the ratio of protein to plasticizer is about 7:1. In some embodiments, the ratio of protein to plasticizer is about 10:1. In some embodiments, the ratio of protein to plasticizer is about 20:1.

In addition to the self-crosslinking capability of protein, the reactive groups can be utilized to modify the proteins further to obtain desired mechanical and physical properties. The most common protein modifications include: addition of crosslinking agents and internal plasticizers, blending with other resins, and forming interpenetrating networks (IPN) with other crosslinked systems. These modifications are intended to improve the mechanical and physical properties of the resin. The properties of the resins can be further improved by adding nanoclay particles and micro- and nano-fibrillated cellulose (MFC, NFC), as described in, for example, Huang, X. and Netravali, A. N., “Characterization of flax yarn and flax fabric reinforced nano-clay modified soy protein resin composites,” Compos. Sci. and Technol. 2007, 67, 2005; and Netravali, A. N.; Huang, X.; and Mizuta, K., “Advanced Green Composites,” Advanced Composite Materials 2007, 16, 269.

In some embodiments, a protein is a plant-based protein. In some embodiments, a provided plant-based protein is obtained from a seed, stalk, fruit, root, husk, stover, leaf, stem, bulb, flower or algae, either naturally occurring or bioengineered.. In some embodiments, the plant-based protein is soy protein.

Soy Protein. Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S. and Netravali, A. N., J. Mater. Sci. 2005, 40, 6263; Chabba, S. and Netravali, A. N., J. Mater. Sci. 2005, 40, 6275; and Huang, X. and Netravali, A. N., Biomacromolecules, 2006, 7, 2783.

Soy protein useful in the present invention includes soy protein from commercially available soy protein sources. The protein content of the soy protein source is proportional to the resulting strength and rigidity of the composite boards because there is a concomitant increase in the crosslinking of the resin. In some embodiments, the soy protein source is treated to remove any carbohydrates, thereby increasing the protein levels of the soy source. In other embodiments, the soy protein source is not treated.

In some embodiments, the concentration of the soy protein in the soy protein source is about 90-95%. In other embodiments, the concentration of the soy protein in the soy protein source is about 70-89%. In still other embodiments, the concentration of the soy protein in the soy protein source is about 60-69%. In still other embodiments, the concentration of the soy protein in the soy protein source is about 45-59%.

In some embodiments, the soy protein source is soy protein isolate.

In some embodiments, the soy protein source is soy protein concentrate. In some embodiments, the soy protein concentrate is commercially available, for example, Arcon S® or Arcon F®, which may be obtained from Archer Daniels Midland.

In some embodiments, the soy protein source is soy flour.

Alternative Proteins. As described above, suitable protein for use in the present invention includes plant-based protein. In certain embodiments, the plant-based protein is other than a soy-based protein. In some embodiments, a provided plant-based protein is obtained from a seed, stalk, fruit, root, husk, stover, leaf, stem, algae, bulb or flower, either naturally occurring or bioengineered. In some embodiments, the plant-based protein obtained from seed is a canola or sunflower protein. In other embodiments, the plant-based protein obtained from grain is rye, wheat or corn protein. In still other embodiments, a plant-based protein is isolated from protein-producing algae.

In some embodiments, a protein suitable for use in the present invention includes animal-based protein, such as collagen, gelatin, casein, albumin, silk and elastin.

In some embodiments, a protein for use in the present invention includes protein produced by microorganisms. In some embodiments, such microorganisms include algae, bacteria and fungi, such as yeast.

In still other embodiments, a protein for use in the present invention includes biodiesel byproducts.

### Strengthening Agent

As described generally above, a provided resin includes a first strengthening agent. In one embodiment, the strengthening agent is a green polysaccharide. In another embodiment, the strengthening agent is a carboxylic acid. In yet another embodiment, the strengthening agent is a nanoclay. In yet another embodiment, the strengthening agent is a microfibrillated cellulose or nanofibrillated cellulose. In some embodiments, the weight ratio of soy protein to first strengthening agent in the biodegradable polymeric composition of the present invention is about 20:1 to about 1:1. In some embodiments, the weight ratio of soy protein to first strengthening agent in the biodegradable polymeric composition of the present invention is about 50:1 to about 1:1.

Green Polysaccharides. In one embodiment, the first strengthening agent is a green polysaccharide. In one embodiment, the strengthening agent is soluble (i.e., substantially soluble in water at a pH of about 7.0 or higher). In some embodiments, the green polysaccharide is a carboxy-containing polysaccharide. In another embodiment, the green polysaccharide is agar, gellan, agaropectin or a mixture thereof

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. Gellan, a linear tetrasaccharide that contains glucuronic acid, glucose and rhamnose units, is known to form gels through ionic crosslinks at its glucuronic acid sites using divalent cations naturally present in most plant tissue and culture media. In the absence of divalent cations, higher concentration of gellan is also known to form strong gels via hydrogen bonding.

The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647. During curing, crosslinking occurs in both the protein and in the polysaccharide, individually to form arrays of cured protein and arrays of polysaccharide. Intermingling occurs because the two arrays are mixed together. Hydrogen bonding occurs between the formed arrays of cured protein and cured polysaccharide because both arrays contain polar groups such as —COOH and —OH groups, and in the case of protein, —NH₂ groups.

In other embodiments, the green polysaccharide is selected from the group comprising carageenan, agar, gellan, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum, galactans, agaropectin and mixtures thereof. In some embodiments, the polysaccharide may be extracted from seaweed and other aquatic plants. In some embodiments, the polysaccharide is agar agar.

Carboxylic acids and esters. In some embodiments, the first strengthening agent is a carboxylic acid or ester. Strengthening agents containing carboxylic acids or esters can crosslink with suitable groups on a protein. In some embodiments, the carboxylic acid or ester strengthening agent is selected from the group comprising caproic acids, caproic esters, castor bean oil, fish oil, lactic acids, lactic esters, poly L-lactic acid (PLLA) and polyols.

Other Polymers. In still other embodiments, the first strengthening agent is a polymer. In some embodiments, the polymer is a biopolymer. In one embodiment, the first strengthening agent is a polymer such as lignin. In other embodiments, the biopolymer is gelatin or another suitable protein gel.

Nanoclay. In some embodiments, the first strengthening agent is a clay. In other embodiments, the clay is a nanoclay. In some embodiments, a nanoclay has a dry particle size of 90% less than 15 microns. The composition can be characterized as green since the nanoclay particles are natural and simply become soil particles if disposed of or composted. The nanoclay does not take part in the crosslinking but is rather present as a reinforcing additive and filler. As used herein, the term “nanoclay” means clay having nanometer thickness silicate platelets. In some embodiments, a nanoclay is a natural clay such as montmorillonite. In other embodiments, a nanoclay is selected from the group comprising fluorohectorite, laponite, bentonite, beidellite, hectorite, saponite, nontronite, sauconite, vermiculite, ledikite, nagadiite, kenyaite and stevensite.

Cellulose. In some embodiments, the first strengthening agent is a cellulose. In some embodiments, a cellulose is a microfibrillated cellulose (MFC) or nanofibrillated cellulose (NFC). MFC is manufactured by separating (shearing) the cellulose fibrils from several different plant varieties. Further purification and shearing, produces nanofibrillated cellulose. The only difference between MFC and NFC is size (micrometer versus nanometer). The compositions are green because the MFC and NFC degrade in compost medium and in moist environments through microbial activity. Up to 60% MFC or NFC by weight (uncured protein plus green strengthening agent basis) improves the mechanical properties of the composition significantly. The MFC and NFC do not take part in any crosslinking but rather are present as strengthening additives or filler. However they are essentially uniformly dispersed in the biodegradable composition and, because of their size and aspect ratio, act as reinforcement.

Other Strengthening Agents. It will be appreciated by those skilled in the art that any cross-linking agent may be used as a strengthening agent in the present invention. For example, in some embodiments, a strengthening agent is a cross-linking agent such as carbodiimides, hydroxysuccinamide esters or hydrazide. In other embodiments, a strengthening agent is an aldehyde, such as formaldehyde or acetaldehyde, or dialdehyde, such as glutaraldehyde or glyoxal. In still other embodiments, a strengthening agent is a polyphosphate such as sodium pyrophosphate. In some embodiments, a strengthening agent is a polyethylene or polypropylene emulsion. In certain embodiments, a strengthening agent is an ethylene-acrylic acid copolymer.

It will be appreciated by those skilled in the art that the resin of the present invention also includes resins containing various combinations of strengthening agents. For example only, in one embodiment the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 1.9% to 65% by weight cured green polysaccharide and from 0.1% to 15% by weight nanoclay (uncured protein plus nanoclay plus polysaccharide basis).

In another embodiment, the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 0.1% to 79.9% by weight cured green polysaccharide and from 0.1% to 79.9% by weight microfibrillated or nanofibrillated cellulose (uncured protein plus polysaccharide plus MFC or NFC basis).

### Plasticizer

As described above, the resin containing a protein and a first strengthening agent optionally further comprises a plasticizer. Without wishing to be bound by any particular theory, it is believed that the addition of a plasticizer reduces the brittleness of the crosslinked protein, thereby increasing the strength and rigidity of the composite. In some embodiments, the weight ratio of plasticizer:(protein+first strengthening agent) is about 1:20 to about 1:4. In some embodiments, the weight ratio of plasticizer:(protein+first strengthening agent) is about 1:50 to about 1:4. Suitable plasticizers for use in the present invention include a hydrophilic or hydrophobic polyol. In some embodiments, a provided polyol is a C₁₋₃ polyol. In one embodiment, the C₁₋₃ polyol is glycerol. In other embodiments, a provided polyol is a C₄₋₇ polyol. In one embodiment, the C₄₋₇ polyol is sorbitol. In some embodiments, the C₄₋₇ polyol is selected from propylene glycol, diethylene glycol and polyethylene glycols in the molecular weight range of 200-400 atomic mass units.

In certain embodiments, a polyol plasticizer is a polyphosphate such as sodium pyrophosphate.

In still other embodiments, a plasticizer is selected from the group comprising environmentally safe phthalates diisononyl phthalate (DINP) and diisodecyl phthalate (DIDP), food additives such as acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols such as sorbitol and glycerol, low molecular weight polysaccharides or a combination thereof.

### Antimoisture Agent

A provided resin optionally further comprises an antimoisture agent which inhibits moisture absorption by the composite. The antimoisture agent may also optionally decrease any odors that result from the use of proteins. In some embodiments, an antimoisture agent is a wax or an oil. In other embodiments, an antimoisture agent is a plant-based wax or plant-based oil. In still other embodiments, an antimoisture agent is a petroleum-based wax or petroleum-based oil. In yet other embodiments, an antimoisture agent is an animal-based wax or animal-based oil.

In some embodiments, a plant-based antimoisture agent is selected from the group comprising carnauba wax, tea tree oil, soy wax, soy oil, lanolin, palm oil, palm wax, peanut oil, sunflower oil, rapeseed oil, canola oil, algae oil, coconut oil and carnauba oil.

In some embodiments, a petroleum-based antimoisture agent is selected from the group comprising paraffin wax, paraffin oil and mineral oil.

In some embodiments, an animal-based antimoisture agent is selected from the group comprising beeswax and whale oil.

In some embodiments, an antimoisture agent is a lignin. In some embodiments, an antimoisture agent is a lignosulfonate. In still other embodiments, an antimoisture agent is stearic acid. In other embodiments, an antimoisture agent is a salt of stearic acid, such as sodium stearate, calcium stearate. In some embodiments, an antimoisture agent is a stearate ester such as polyethylene glycol stearate, methyl-, ethyl-, propyl, butyl-stearate, and the like, octyl-stearate, isopropyl stearate, myristyl stearate, ethylhexyl stearate, cetyl stearate and isocetyl stearate.

In some embodiments, an antimoisture agent is a cross-linking agent such as carbodiimides, hydroxysuccinamide esters or hydrazide. In other embodiments, an antimoisture agent is an aldehyde, such as formaldehyde or acetaldehyde, or dialdehyde, such as glutaraldehyde or glyoxal. In still other embodiments, an antimoisture agent is a polyphosphate such as sodium pyrophosphate. In some embodiments, an antimoisture agent is a polyethylene or polypropylene emulsion. In certain embodiments, an antimoisture agent is an ethylene-acrylic acid copolymer.

It will be appreciated by those skilled in the art that, in some embodiments, one additive in the present invention may serve a dual purpose. For example, as described above, in some embodiments, a cross-linking agent such as a carbodiimide, hydroxysuccinamide ester or hydrazide is both a first strengthening agent and an antimoisture agent. In other embodiments, a polyphosphate is both a plasticizer and an antimoisture agent. Those skilled in the art can readily identify which agents serve more than one purpose.

### Antimicrobial Agent

In accordance with the present invention, the protein resin may optionally contain an antimicrobial agent. In some embodiments, an antimicrobial agent is an environmentally safe agent. In some embodiments, an antimicrobial agent is a guanidine polymer. In some embodiments, the guanidine polymer is Teflex®. In other embodiments, an antimicrobial agent is selected from the group comprising essential oils such as tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, thyme oil. In some embodiments, an antimicrobial agent is selected from parabens, paraben salts, quaternary ammonium salts such as n-alkyl dimethylbenzyl ammonium chloride or didecyldimethyl ammonium chloride, allylamines, echinocandins, polyene antimycotics, azoles, isothiazolinones, imidazolium, sodium silicates, sodium carbonate, sodium bicarbonate, sulfite salts such as sodium or potassium sulfite, bisulfite salts such as sodium or potassium bisulfite, metabisulfite salts such as sodium or potassium metabisulfite, benzoic acid, benzoate salts such as sodium or potassium benzoate, potassium iodide, silver, copper, sulfur, grapefruit seed extract, lemon myrtle, olive leaf extract, patchouli, citronella oil, orange oil, pau d'arco and neem oil. In some embodiments, the parabens are selected from the group comprising methyl, ethyl, butyl, isobutyl, isopropyl and benzyl paraben and salts thereof. In some embodiments, the azoles are selected from the group comprising imidazoles, triazoles, thiazoles and benzimidazoles.

In some embodiments, an antimicrobial agent is a boric acid, or an acceptable salt thereof. In some embodiments, an antimicrobial agent is a boric acid salt, such as sodium borate, sodium tetraborate, disodium tetraborate, potassium borate, potassium tetraborate, and the like.

In some embodiments, an antimicrobial agent is Microban™ or pyrithione salts such as zinc pyrithione, sodium pyrithione, etc.

### Composites

In some embodiments, a provided resin is useful for combination with green reinforcing materials to form a composite.

### Fiber

In some embodiments, the present invention provides a composite comprising a biodegradable polymeric composition, as described herein. In certain embodiments, a provided composite is comprised of a protein, a first strengthening agent and an optional second strengthening agent of natural origin that can be a particulate material, a fiber, or a combination thereof. More precisely, the second strengthening agent of natural origin includes green reinforcing fiber, filament, yarn, and parallel arrays thereof, woven fabric, knitted fabric and/or non-woven fabric of green polymer different from the protein, or a combination thereof

In some embodiments, a second strengthening agent is a woven or non-woven, scoured or unscoured natural fiber. In some embodiments, a natural scoured, non-woven fiber is cellulose-based fiber. In other embodiments, a natural scoured, non-woven fiber is animal-based fiber.

In some embodiments, a cellulose-based fiber is fiber obtained from a commercial supplier and available in a variety of packages, for example loose, baled, bagged, or boxed fiber. In other embodiments, the cellulose-based fiber is selected from the group comprising kenaf, hemp, flax, wool, silk, cotton, ramie, sorghum, raffia, sisal, jute, sugar cane bagasse, coconut, pineapple, abaca (banana), sunflower stalk, sunflower hull, peanut hull, wheat straw, oat straw, hula grass, henequin, corn stover, bamboo and saw dust. In other embodiments, a cellulose-based fiber is a recycled fiber from clothing, wood and paper products. In still other embodiments, the cellulose-based fiber is manure. In yet other embodiments, the cellulose-based fiber is regenerated cellulose fiber such as viscose rayon and lyocell.

In some embodiments, an animal-based fiber includes hair or fur, silk, fiber from feathers from a variety of fowl including chicken and turkey, and regenerated varieties such as spider silk and wool.

In some embodiments, a non-woven fiber may be formed into a non-woven mat.

In some embodiments, a non-woven fiber is obtained from the supplier already scoured. In other embodiments, a non-woven fiber is scoured to remove the natural lignins and pectins which coat the fiber. In still other embodiments, a non-woven fiber is used without scouring.

In yet other embodiments, a fiber for use in the present invention is scoured or unscoured, woven fabric. In some embodiments, a woven fabric is selected from the group comprising burlap, linen or flax, wool, cotton, hemp, silk and rayon. In some embodiments, the woven fabric is burlap. In another embodiment, the woven fabric is a dyed burlap fabric. In still another embodiment, the woven fabric is an unscoured burlap fabric.

In still other embodiments, a fiber for use in the present invention is a combination of non-woven fiber and woven fabric.

In some embodiments, the woven fabric is combined with a provided resin comprising a protein and a first strengthening agent and pressed into a composite as described herein, infra.

In certain embodiments, the composite is comprised of a provided resin comprising a protein, a first strengthening agent and optionally a second strengthening agent, wherein the second strengthening agent is impregated with a provided resin to form a mat known as a prepreg. Two or more prepregs may be optionally stacked to achieve a desired thickness.

In some embodiments, the second strengthening agent is pretensioned prior to being impregnated and/or cured.

Optionally, the prepregs are stacked or interlayered with one or more optionally impregnated woven fabrics, resulting in a stronger and more durable composite. In some embodiments, the prepregs are interlayered with optionally impregnated woven burlap. In some embodiments, the outer surfaces of the stack of prepregs are covered with decorative or aesthetic layers such as fabrics or veneers. In some embodiments, the fabrics are silkscreened to produce a customized composite. Significantly, the present invention further provides for a one-step process for pressing and veneering a composite without the use of a formaldehyde-based adhesive, as the resin itself crosslinks the prepregs with the veneer, resulting in a biodegradable veneered composite. In other embodiments, the veneer is adhered to the composite with a suitable adhesive, for example wood glue.

In some embodiments, the stacked prepregs can be pressed directly into a mold, thereby resulting in a contoured composite. In a further embodiment, the prepregs can be both veneered and molded in a single step. Wood for a veneer ply includes but is not limited to any hardwood, softwood or bamboo. In some embodiments, the veneer is bamboo, pine, white maple, red maple, poplar, walnut, oak, redwood, birch, mahogany, ebony and cherry wood.

In some embodiments, the composites can contain variable densities throughout a single board. In some embodiments, the variable density is created by a mold which is contoured on one surface but flat on the other, thereby applying variable pressure to the contoured surface. In other embodiments, the variable density is created by building up uneven layers of prepregs, where the more heavily layered areas result in the more dense sections of the composite boards.

In some embodiments, the pressing of the prepregs contains a tooling step, which may occur before or after the pressing or curing step but prior to or after the release of the composite from the mold. In some embodiments, the tooling step occurs after the prepregs are loaded into the mold but prior to the pressing or curing step. Such step comprises subjecting the mold containing the prepregs to a tooling apparatus which trims the outer edges of the prepregs which, when pressed or cured, produce a composite without the need for further shaping or refining. In some embodiments, the prepreg material trimmed from the outside of the mold can be recycled by grinding up and adding the trimmings back into the resin.

In other embodiments, the tooling step occurs after the pressing or curing of the composite but before the composite is released from the mold.

As will be appreciated by those skilled in the art, composites comprising biodegradable compositions are useful in the manufacture of consumer products. Consumer products composed of composites comprising biodegradable compositions are fire-retardant as compared to conventional materials such as wood and particle board. Of particular note, consumer products comprised of composites comprising biodegradable compositions, such as furniture, sports equipment and home decor, are renewable and compostable at the end of their useful life, thereby reducing landfill waste. Further, in some embodiments, such composites are produced without the use of toxic chemicals such as formaldehyde or highly reactive agents such as isocyanates or epoxys.

In certain embodiments, composites comprising biodegradable compositions are incorporated into furniture. In some embodiments, the furniture may include tables, desks, chairs, shelving, buffets, wet bars, benches, chests, vanities, stools, dressers, bed frames, futon frames, baby cribs, entertainment stands, bookcases, etc. In some embodiments, the furniture may include couches and recliners containing frames comprised of composites comprising biodegradable composition. In some embodiments, the furniture may be office furniture, such as cubicle walls. In some embodiments, the cubicle walls have variable densities to accommodate push pins. The cubicle walls may also contain a plurality of channels within which wires and cables may be concealed. In other embodiments, the office furniture may be desks, chairs or shelving. In some embodiments, the composites are customized with inlays, logos, colors, designs, etc.

In some embodiments, composites comprising biodegradable compositions are used to create home decor products. Such home decor products include picture frames, wall coverings, cabinets and cabinet doors, decorative tables, serving trays and platters, trivets, placemats, decorative screens, decorative boxes, corkboards, etc. In some embodiments, the composites are customized with inlays, logos, colors, designs, etc.

In some embodiments, composites comprising biodegradable compositions are useful in the manufacturing of tools and industrial equipment, including ladders, tool handles such as hammer, knife or broom handles, saw horses, etc.

In some embodiments, composites comprising biodegradable compositions are useful in the manufacturing of musical instruments, including guitars, pianos, harpsichords, violins, cellos, bass, harps, violas, banjos, lutes, mandolins and musical bows.

In some embodiments, composites comprising biodegradable compositions are useful in the manufacturing of musical instruments, including guitars, pianos, harpsichords, violins, cellos, bass, harps, violas, banjos, lutes, mandolins and musical bows.

In some embodiments, composites comprising biodegradable compositions are useful in the manufacturing of caskets or coffins. Of particular note, it will be appreciated that the casket will be engineered to biodegrade at the same or slightly slower rate than its contents. In some embodiments, the caskets are veneered during the molding/pressing process.

In some embodiments, composites comprising biodegradable compositions are useful in the manufacturing of sports equipment. Such sports equipment includes skateboards, snowboards, snow skis, tennis racquets, golf clubs, bicycles, scooters, shoulder, elbow and knee pads, basketball backboards, lacrosse sticks, hockey sticks, skim boards, wakeboards, water-skis, boogie boards, surf boards, wake skates, snow skates, snow shoes, etc. In some embodiments, the composites are customized with inlays, logos, colors, designs, etc.

In some embodiments, composites comprising biodegradable compositions are useful in the manufacturing of personal products, such as hats, pins, buttons, bracelets, necklaces, etc.

In some embodiments, composites comprising biodegradable compositions are useful in the manufacturing of electronic items, such as circuit boards.

In other embodiments, composites comprising biodegradable compositions are useful in the manufacturing of product casing, packaging and mass-volume disposable consumer goods.

In some embodiments, composites comprising biodegradable compositions are useful in the manufacturing of building materials.

In other embodiments, composites comprising biodegradable compositions are useful in the manufacturing of automobile, airplane, train, bicycle or space vehicle parts.

### General Process for Preparing Provided Composites

In preparing a resin of the present invention, the first strengthening agent is dissolved in water to form a solution or weak gel, depending on the concentration of the first strengthening agent. The resulting solution or gel is added to the initial protein suspension, with or without a plasticizer, under conditions effective to cause dissolution of all ingredients to produce a resin comprising a biodegradable polymeric composition.

The resin comprising a protein and a first strengthening agent, and further optionally comprising an antimoisture agent, an antimicrobial agent, and an additional strengthening agent is then optionally allowed to impregnate a second strengthening agent, consisting of woven or non-woven fibers. The impregnated fiber structure is optionally allowed to dry, and may be optionally cut to desired size and shape. The impregnated fiber structure is then formed into a sheet of resin-impregnated biodegradable, renewable natural fiber that when cured, either by applying heat or heat and pressure will form a layer. To obtain thicker composite sheets, a plurality of sheets can be stacked for curing. The sheets can be stacked with unidirectional fibers and yarns at different angles in different layers.

### Exemplification

A biodegradable resin in accordance with the present invention may be prepared by the following illustrative procedure:

The agar mixture was prepared in a separate container by mixing an appropriate amount of agar with an appropriate amount of water at or below room temperature.

A 50L mixing kettle was charged with 25L water and heated to about 50° C. to about 85° C. Half of the appropriate amount of protein was added. To the resulting mixture were added Teflex® and sorbitol, followed by the preformed agar mixture. The remainder of the protein was then added, the pH of the mixture was adjusted to about 7-14 with a suitable base, for example a 1 N sodium hydroxide solution, and the volume of the mixture was adjusted to about 55 L by the addition of a sufficient volume of water. The mixture was allowed to stir at about 70° C. to about 90° C. for 30-90 minutes. The beeswax was then added and the resin mixture was allowed to stir at about 70° C. to about 90° C. for about 10-30 minutes. The resin was then transferred to the impregnation tank and maintained at about 55° C. to about 110° C.

The resin solution so produced was applied to a fiber structure such as a mat or sheet in an amount so as to thoroughly impregnate the structure and coat its surfaces. The fiber mat was subjected to the resin in the impregger for about 5 minutes, before being loosely rolled and optionally allowed to stand for about 0-5 hours. The resin-impregnated mat was then optionally resubjected to the resin by additional passes through the impregger, before being loosely rolled and allowed to stand for about 0-5 hours. In some embodiments, the prepreg is processed without a standing or resting step, for example in a high-throughput process utilizing continuously moving machinery such as a conveyor belt.

The fiber structure so treated was pre-cured by drying, for example, in an oven, at a temperature of about 35-70° C. to form what is referred to as a prepreg. In another embodiment, the prepreg is dried using steam heat. In yet another embodiment, the prepreg is dried using microwave technology. In yet another embodiment, the prepreg is dried using infrared technology. Alternatively, the structure is dried on one or more drying racks at room temperature or at outdoor temperature.

Once dry, the resin-impregnated mats were conditioned or equilibrated to a uniform dryness. In some embodiments, the mats were conditioned for about 0-7 days. Once conditioned, the prepreg has a moisture content of between 2 and 40 percent. In some embodiments, the moisture content of the dried prepreg is between about 5 and 15 percent. In other embodiments, the moisture content of the dried prepreg is between about 5 and 10 percent.

The layered prepregs and optional decorative coverings were pressed at a temperature of about 110° C. to about 140° C. and pressure of about 0.001-200 tons per square foot. The strength and density of the resulting composites are proportional to the pressure applied to the prepregs. Thus, when a low density composite is required, little to no pressure is applied.

We claim:

1. A biodegradable polymeric composition comprising a protein, a first strengthening agent, and a plasticizer.

2. The composition of claim 1, wherein the protein is selected from a plant-based protein, an animal-based protein and a biodiesel byproduct.

3. The composition of claim 2, wherein the plant-based protein is a soy-based protein from a soy protein source.

4. The composition of claim 3, wherein the soy protein source is selected from soy flour, soy protein isolate and soy protein concentrate.

5. The composition of claim 2, wherein the plant-based protein is obtained from a seed, stalk, fruit, root, husk, stover, leaf, stem, bulb, flower, or algae, either naturally occurring or bioengineered, and combinations thereof

6. The composition of claim 5, wherein the plant-based protein is selected from the group comprising soy, canola, sunflower, rye, wheat, corn, and combinations thereof

7. The composition of claim 2, wherein the animal-based protein is selected from the group comprising collagen, gelatin, casein, albumin, silk, elastin, and combinations thereof

8. The composition of claim 1, wherein the first strengthening agent is selected from a green polysaccharide, a carboxylic acid or ester, a nanoclay, a cellulose or a cross-linking agent.

9. The composition of claim 8, wherein the green polysaccharide is selected from the group comprising gelatin, carageenan, other suitable protein gels, agar, gellan, agaropectin, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum and combinations thereof.

10. The composition of claim 8, wherein the carboxylic acid or ester is selected from the group comprising caproic acids, caproic esters, castor bean oil, fish oil, lactic acids, lactic esters, poly L-lactic acid (PLLA), polyols and combinations thereof.

11. The composition of claim 8, wherein the nanoclay is selected from the group comprising montmorillonite, fluorohectorite, laponite, bentonite, beidellite, hectorite, saponite, nontronite, sauconite, vermiculite, ledikite, nagadiite, kenyaite, stevensite and combinations thereof.

12. The composition of claim 8, wherein the cellulose is a microfibrillated cellulose or a nanofibrillated cellulose.

13. The composition of claim 8, wherein the cross-linking agent is selected from carbodiimides, hydroxysuccinamide esters, hydrazides, aldehydes or dialdehydes, polyphosphates, polyethylene or polypropylene emulsions and ethylene-acrylic acid copolymers.

14. The composition of claim 1, wherein the first strengthening agent is a combination of a green polysaccharide, a carboxylic acid or ester, a nanoclay, a cellulose or a cross-linking agent.

15. The composition of claim 1, wherein the plasticizer is a polyol.

16. The composition of claim 15, wherein the polyol is selected from glycerol, sorbitol, propylene glycol, diethylene glycol, polypropylene glycols in the molecular weight range of 200-400 amu or polyphosphates.

17. The composition of claim 1, further comprising an antimoisture agent.

18. The composition of claim 17, wherein the antimoisture agent is selected from a petroleum-based wax, a petroleum-based oil, an animal-based wax, an animal-based oil, a plant-based wax or a plant-based oil.

19. The composition of claim 18, wherein the antimoisture agent is selected from the group comprising paraffin wax, paraffin oil, mineral oil, beeswax, whale oil, carnauba wax, tea tree oil, soy wax, soy oil, lanolin, palm oil, palm wax, peanut oil, sunflower oil, rapeseed oil, canola oil, algae oil, coconut oil, carnauba oil, lignin, stearic acid, stearate salt, or stearate ester, carbodiimides, hydroxysuccinamide esters, hydrazides, aldehydes or dialdehydes, polyphosphates, polyethylene or polypropylene emulsions and ethylene-acrylic acid copolymers.

20. The composition of claim 1 further comprising an antimicrobial agent.

21. The composition of claim 20, wherein the antimicrobial agent is selected from Teflex®, boric acid or a salt thereof, Microban™, pyrithione salts, parabens, paraben salts, quaternary ammonium salts, allylamines, echinocandins, polyene antimycotics, azoles, isothiazolinones, imidazolium, sodium silicates, sodium carbonate, sodium bicarbonate, potassium iodide, silver, copper, or sulfur, sulfite salts, bisulfite salts, metabisulfite salts, benzoic acid, benzoate salts, or an essential oil comprising tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, thyme oil, grapefruit seed extract, lemon myrtle, olive leaf extract, patchouli, citronella oil, orange oil, pau d'arco or neem oil, or a mixture thereof.

22. A composite comprising a biodegradable composition and a second strengthening agent.

23. The biodegradable composite of claim 22, wherein the second strengthening agent is selected from a non-woven fiber and a woven fabric.

24. The composite of claim 23, wherein the second strengthening agent is selected from a cellulose-based fiber, a cellulose-based fabric, an animal-based fiber and an animal-based fabric.

25. The composite of claim 24, wherein the cellulosed-based fiber or fabric is selected from the group comprising kenaf, hemp, flax, wool, silk, cotton, ramie, sorghum, raffia, sisal, burlap, jute, sugar cane bagasse, coconut, pineapple, abaca (banana), sunflower stalk, sunflower hull, peanut hull, wheat straw, oat straw, hula grass, henequin, corn stover, bamboo, saw dust, recycled fiber from clothing and paper products, manure, viscose rayon and lyocell.

26. The composite of claim 24, wherein the animal-based fiber or fabric is selected from the group comprising hair, fur, silk, feathers, spider silk and wool.

27. The composite of claim 23, wherein the second strengthening agent is scoured.

28. The composite of claim 23, wherein the second strengthening agent is unscoured.

29. The composite of claim 23, wherein the woven fabric is selected from the group comprising burlap, linen, flax, wool, cotton, hemp, silk and rayon.

30. The composite of claim 23, wherein the woven fabric is dyed.

31. The composite of claim 22, wherein at least one outer surface is decorated.

32. The composite of claim 22, wherein at least one outer surface is veneered.

33. The composite of claim 32, wherein the veneer is selected from the group comprising hardwood, softwood or bamboo.

34. The composite of claim 33, wherein the veneer is selected from the group comprising pine, white maple, bamboo, red maple, poplar, walnut, oak, redwood, birch, mahogany, ebony and cherry wood.

35. A method of preparing a composite comprising a biodegradable polymeric composition, wherein the method comprises the steps of:
impregnating a fiber or fabric with the biodegradable polymeric composition of claim 1 to form at least one prepreg;
optionally stacking a plurality of prepregs; and
pressing at least one prepreg under conditions sufficient to form the composite.

36. The method of claim 35, comprising the step of stacking one or more prepregs before pressing.

37. The method of claim 35, wherein the prepreg is pressed into a mold.

38. The method of claim 35, wherein the composite is trimmed prior to release from the press.

39. The method of claim 35, wherein the prepregs are stacked to produce a composite with areas of variable density.

40. The method of claim 35, wherein the at least one prepreg is pretensioned prior to pressing.

41. The method of claim 35, wherein a decorative outer layer is applied to the composite during the pressing step.

42. The method of claim 41, wherein the decorative layer is selected from a wood veneer ply, a colored fabric, a fabric containing a design and a silkscreened fabric.

43. An article of manufacture comprising the composite of claim 22.

44. The article of claim 43, selected from a furniture or cabinet component.
